(19) United States
(12) Patent Application Publication
(10) Pub. No.: US 2025/0058927 A1
(43) Pub. Date: Feb. 20, 2025

(54) Tray For Food Products

(71) Applicant: Graphic Packaging International, LLC, Atlanta, GA (US)

(72) Inventor: Thomas Brink, West Chicago, IL (US)

(21) Appl. No.: 18/806,947

(22) Filed: Aug. 16, 2024

Related U.S. Application Data
(60) Provisional application No. 63/533,155, filed on Aug. 17, 2023.

(51) Int. Cl. B65D 5/26; B31B 50/26; B31B 100/00; B31B 110/30; B31B 120/00; B65D 5/20

(52) U.S. Cl. CPC B65D 5/26; B31B 50/262; B65D 5/2047; B31B 2100/0024; B31B 2110/30; B31B 2120/002

(57) ABSTRACT

A tray for at least one food product includes a plurality of panels extending at least partially around an interior of the tray, the plurality of panels including a bottom panel, a front panel, a back panel, and at least one side panel, a plurality of top end flaps foldably connected to a respective panel of the plurality of panels and cooperating to form a rim extending outwardly from the panels, a plurality of side end flaps foldably connected to a respective panel of the plurality of panels, and locking features including a locking end flap foldably connected to at least one side end flap of the plurality of side end flaps, a locking tab protruding from the locking end flap, and a plurality of locking flaps at least partially positioned in a respective panel of the plurality of panels at least partially receiving a respective locking tab therebetween.

### CROSS-REFERENCE TO RELATED APPLICATION

The present application claims the benefit of and priority to U.S. Provisional Patent Application No. 63/533,155, filed on Aug. 17, 2023.

### INCORPORATION BY REFERENCE

The disclosure of U.S. Provisional Patent Application No. 63/533,155, filed on Aug. 17, 2023, is hereby incorporated by reference for all purposes as if set forth in its entirety.

### BACKGROUND OF THE DISCLOSURE

The present disclosure generally relates to trays for holding at least one food product.

### SUMMARY OF THE DISCLOSURE

According to one aspect, the disclosure is generally directed to a tray for holding at least one food product, the tray comprising a plurality of panels extending at least partially around an interior of the tray, the plurality of panels comprising a bottom panel, a front panel, a back panel, and at least one side panel, a plurality of top end flaps foldably connected to a respective panel of the plurality of panels and cooperating to form a rim extending outwardly from the plurality of panels, a plurality of side end flaps foldably connected to a respective panel of the plurality of panels, and locking features including a locking end flap foldably connected to at least one side end flap of the plurality of side end flaps, a locking tab protruding from the locking end flap, and a plurality of locking flaps at least partially positioned in a respective panel of the plurality of panels at least partially receiving a respective locking tab therebetween.

A blank for forming a tray for holding at least one food product, the blank comprising a plurality of panels for extending at least partially around an interior of the tray formed from the blank, the plurality of panels comprising a bottom panel, a front panel, a back panel, and at least one side panel, a plurality of top end flaps foldably connected to a respective panel of the plurality of panels for cooperating to form a rim extending outwardly from the plurality of panels when the tray is formed from the blank, a plurality of side end flaps foldably connected to a respective panel of the plurality of panels, and locking features comprising a locking end flap foldably connected to at least one side end flap of the plurality of side end flaps, a locking tab protruding from the locking end flap, and a plurality of locking flaps at least partially positioned in a respective panel of the plurality of panels for at least partially receiving a respective locking tab therebetween when the tray is formed from the blank.

A method of forming a tray for holding at least one food product, the method comprising obtaining a blank comprising a plurality of panels, the plurality of panels comprising a bottom panel, a front panel, a back panel, and at least one side panel, the blank further comprising a plurality of top end flaps foldably connected to a respective panel of the plurality of panels, a plurality of side end flaps foldably connected to a respective panel of the plurality of panels, and locking features comprising a locking end flap foldably connected to at least one side end flap of the plurality of side end flaps, a locking tab protruding from the locking end flap, and a plurality of locking flaps at least partially positioned in a respective panel of the plurality of panels, positioning the plurality of panels extending at least partially around an interior of the tray, positioning the plurality of top end flaps cooperating to form a rim extending outwardly from the plurality of panels when the tray is formed from the blank, and positioning the locking tab extending at least partially between the plurality of locking flaps.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank used to form a tray according to an exemplary embodiment of the disclosure.

FIG. 1A is an enlarged view of a portion of the blank of FIG. 1.

FIG. 2 is a perspective view of a partial formation of a tray formed from the blank of FIG. 1 according to an exemplary embodiment of the disclosure.

FIG. 3 is a perspective view of a tray formed from the blank of FIG. 1 and covered with a lidding film according to an exemplary embodiment of the disclosure.

FIG. 4 is another perspective view of the tray of FIG. 3.

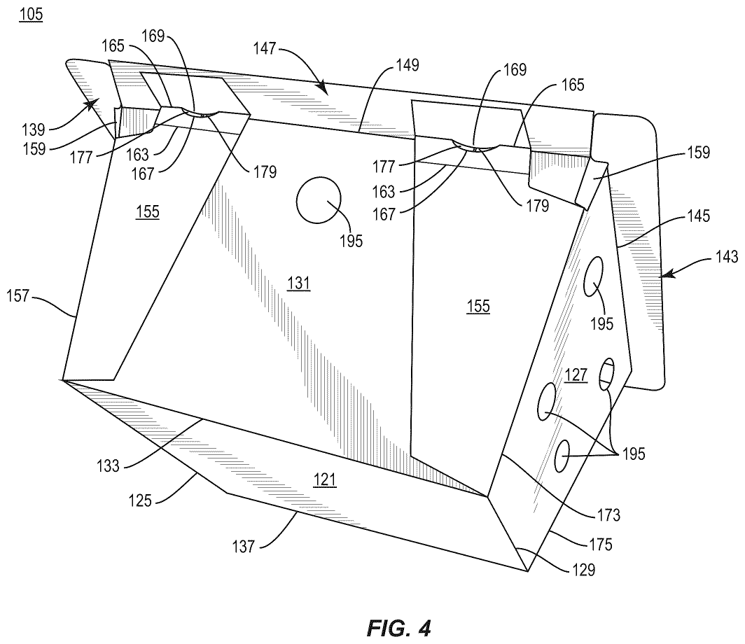

FIG. 5 is a plan view of an exterior surface of a blank used to form a tray according to an alternative exemplary embodiment of the disclosure.

FIG. 5A is an enlarged view of a portion of the blank of FIG. 5.

Corresponding parts are designated by corresponding reference numbers throughout the drawings.

### DETAILED DESCRIPTION OF THE EXEMPLARY EMBODIMENTS

Trays according to the present disclosure can accommodate articles of numerous different shapes. For the purpose of illustration and not for the purpose of limiting the scope of the disclosure, the following detailed description describes articles such as food products, e.g., fruit or vegetable items. In one embodiment, articles described herein can be fruits such as tomatoes (e.g., cherry tomatoes, etc.), berries (e.g., blueberries, raspberries, blackberries, strawberries, etc.), apples, oranges, tangerines, elementines, lemons, limes, cherries, etc. In another embodiment, articles described herein can be product packages, containers, bottles, cans, etc., that are at least partially disposed within the tray embodiments. The articles can be used for packaging food and beverage products, for example. Packaged articles can be made from materials suitable in composition for packaging the particular food or beverage item, and the materials include, but are not limited to, glass; aluminum and/or other metals; plastics such as PET, LDPE, LLDPE, HDPE, PP, PS, PVC, EVOH, and Nylon; composite materials; and the like, or any combination thereof.

The articles described herein can include different types of food or beverage products, containers thereof, and/or having different shapes, without departing from the disclosure. In this specification, the terms “lower,” “bottom,” “upper,” and “top” indicate orientations determined in relation to fully erected and upright trays. As described herein, trays can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

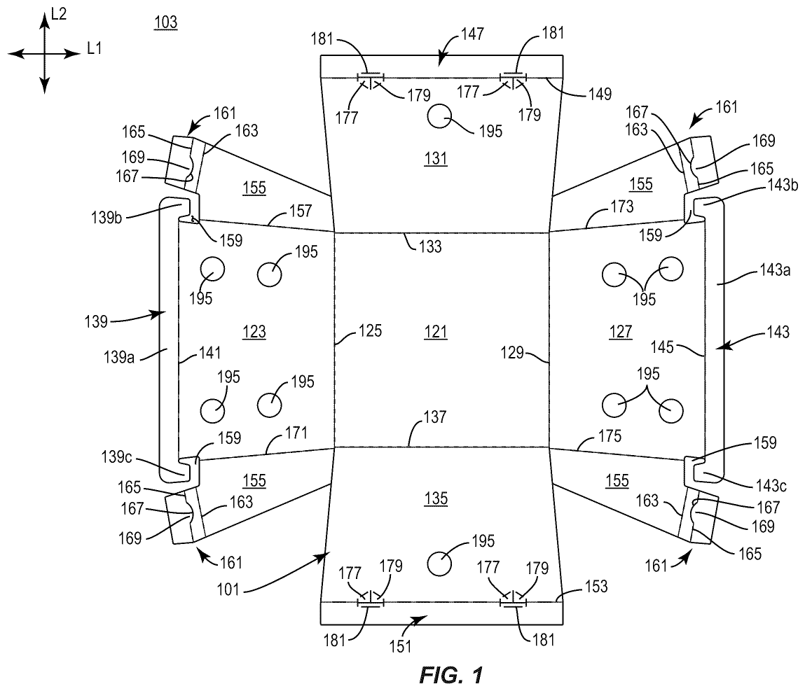

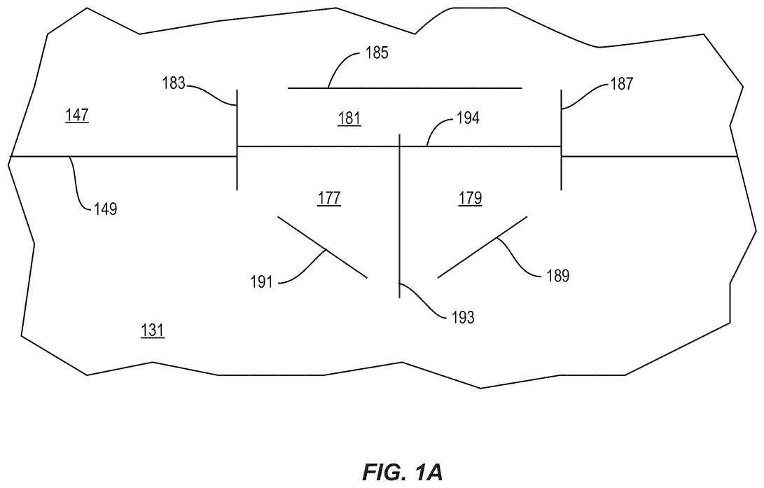

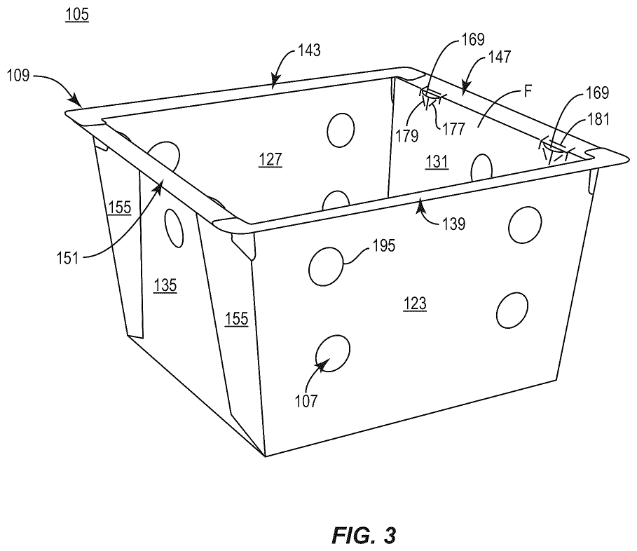

FIG. 1 is a plan view of an exterior surface 101 of a blank, generally indicated at 103, used to form a tray 105 (FIG. 3) according to an exemplary embodiment of the disclosure. FIG. 1A is an enlarged view of a portion of the blank of FIG. 1. While the constructs formed from the blanks disclosed herein are described as trays, it will be understood that such constructs can be considered cartons, containers, other constructs, etc., without departing from the disclosure.

As described further herein, the blank 103 includes engagement features for forming engagement features of the tray 105 that provide one or more surfaces for engaging a machine element or other component of a system associated with the formation, loading, and/or packaging of the tray 105. In addition, the engagement features of the blank 103/tray 105 can provide one or more surfaces for receiving a lidding film, e.g., a polymeric film or other cover overlying the tray 105 to maintain one or more conditions of food products held therein. The engagement features of the tray 105 can also be arranged so as to maintain a structural integrity, e.g., rigidity/resistance to deformation, of the tray 105.

As shown, the blank 103 has a longitudinal axis L1 and a lateral axis L2, and includes a plurality of panels for extending at least partially around an interior 107 of the tray 105 when the tray 105 is formed from the blank 103. The panels can include a bottom panel 121, a front panel 123 foldably connected to the bottom panel 121 at a lateral fold line 125, a back panel 127 foldably connected to the bottom panel 121 at a lateral fold line 129, a first side panel 131 foldably connected to the bottom panel 121 at a longitudinal fold line 133, and a second side panel 135 foldably connected to the bottom panel 121 at a longitudinal fold line 137.

The blank 103/tray 105 can also include a plurality of end flaps foldably connected to respective panels of the plurality of panels. In some embodiments, the plurality of end flaps can be foldably connected to a respective panel of the front panel 123, the back panel 127, the first side panel 131, and the second side panel 135.

A front top end flap 139 can be foldably connected to the front panel 123 at a lateral fold line 141. As shown, the front top end flap 139 can include a central portion 139a and a pair of end portions 139b, 139c extending therefrom. In some embodiments, the central portion 139a of the front panel 123 can be positioned generally parallel to the lateral axis L2, and the end portions 139b, 139c can extend away therefrom along axes generally parallel to the longitudinal axis L1.

Similarly, a back top end flap 143 can be foldably connected to the back panel 127 at a lateral fold line 145. The back top end flap 143 can similarly have a central portion 143a extending along an axis generally parallel to the lateral axis L2, and a pair of end portions 143b, 143c extending away therefrom along axes generally parallel to the longitudinal axis L1.

A first side top end flap 147 can be foldably connected to the first side panel 131 at a longitudinal fold line 149. Similarly, a second side top end flap 151 can be foldably connected to the second side panel 135 at a longitudinal fold line 153. As described further herein, the top end flaps 139, 143, 147, 151 are for cooperating to form a flange or rim of the tray 105.

With continued reference to FIG. 1, the plurality of end flaps can further include a first front end flap 155 (broadly, “first side end flap” or “second side end flap” or “third side end flap” or “fourth side end flap”) foldably connected to the front panel 123 at an oblique fold line 157. As shown, the front end flap 155 can at least partially define a notch 159 formed along an upper free edge thereof to provide a space into which the end portion 139b of the top end flap 139 extends from the central portion 139a thereof.

As also shown, a first locking end flap 161 (broadly, “first locking end flap” or “second locking end flap” or “third locking end flap” or “fourth locking end flap”) can be foldably connected to the front end flap 155 at an oblique fold line 163. A further oblique fold line 165 can be positioned along the locking end flap 161 spaced away from the fold line 163, and interrupted by a cut 167 defining a locking tab 169, as described further herein.

A second front end flap 155 (broadly, “first side end flap” or “second side end flap” or “third side end flap” or “fourth side end flap”) can be foldably connected to an opposite edge of the front panel 123 at an oblique fold line 171. As shown, the second front end flap 155 can be generally similar to the first front end flap 155, mirrored over a line parallel to the longitudinal axis L1, and provided with an accompanying locking end flap 161 (broadly, “first locking end flap” or “second locking end flap” or “third locking end flap” or “fourth locking end flap”) and associated features.

Similarly, a first back end flap 155 (broadly, “first side end flap” or “second side end flap” or “third side end flap” or “fourth side end flap”) can be foldably connected to the back panel 127 at an oblique fold line 173, and a second back end flap 155 (broadly, “first side end flap” or “second side end flap” or “third side end flap” or “fourth side end flap”) can be foldably connected to an opposite edge of the back panel 127 at an oblique fold line 175. The first back end flap 155 and the second back end flap 155 can each be provided with an accompanying locking end flap 161 (broadly, “first locking end flap” or “second locking end flap” or “third locking end flap” or “fourth locking end flap”) and associated features.

As shown, the first back end flap 155 and second back end flap 155 can be generally similar to the respective first front end flap 155 and second front end flap 155, mirrored over a line parallel to the lateral axis L2.

The blank 103 and the tray 105 formed therefrom can also include locking features. In addition to the locking tabs 169 and associated features described above, and with additional reference to FIG. 1A, respective pluralities of locking flaps 177 (broadly, “first locking flap”), 179 (broadly, “second locking flap”), 181 (broadly, “third locking flap”) (broadly, “first plurality of locking flaps” or “second plurality of locking flaps” or “third plurality of locking flaps” or “fourth plurality of locking flaps”, collectively) can be at least partially defined by respective cuts 183, 185, 187, 189, 191, 193, 194 so as to be at least partially foldably connected and/or separable to the first side panel 131 and each other at the respective cuts. Furthermore, at least the locking flap 181 can be at least partially foldably connected to the top end flap 147 via the cut 185, which can at least partially form a line of weakening about which the locking flap 181 folds. In this regard, the respective pluralities of locking flaps 177, 179, 181 can be at least partially positioned in the first side panel 131 for at least partially receiving a respective locking tab 169 therebetween.

In the illustrated embodiment, the cuts 183, 187 can be lateral cuts that can be longitudinally spaced apart and at least partially interrupting the fold line 149, and the cut 194 (broadly, “second cut”) can extend longitudinally from the cut 183 to the cut 187 so as to at least partially separate/make separable the locking flaps 177, 179. The cut 193 (broadly, “first cut”) can be a longitudinal cut intersecting the cut 194 and extending at least partially laterally away therefrom so as to at least partially separate/make separable the locking flap 181 and the locking flaps 177, 179. In some embodiments, the cut 194 can extend at least partially into the locking flap 181. In some embodiments, one or more of the cuts 183, 185, 187, 189, 191, 193, 194 can be a line of weakening having a different configuration.

The oblique cut 191 can be positioned between the cuts 183, 193 and the oblique cut 189 can be positioned between the cut 193 and the cut 187. As shown, the cut 185 can be a longitudinal cut positioned in generally parallel and spaced relation with the longitudinal cut 194.

Accordingly, respective pluralities of locking flaps 177, 179, 181 can be provided in generally abutting relation, with respective locking flaps 177, 179 abutting each other and with respective locking flaps 181 abutting both respective locking flaps 177, 179 and extending therealong. Pluralities of locking flaps 177, 179, 181 can be positioned in longitudinally spaced apart relation along the first side panel 131.

The pluralities of locking flaps 177, 179, 181 can be positioned for at least partially exposing a locking opening for at least partially receiving a respective locking tab 169 to facilitate formation of the tray 105, as described further herein.

Similarly, respective pluralities of locking flaps 177, 179, 181 (broadly, “first plurality of locking flaps” or “second plurality of locking flaps” or “third plurality of locking flaps” or “fourth plurality of locking flaps”) can be at least partially foldably connected and/or separable from the second side panel 135 and from each other at the respective cuts 183, 185, 187, 189, 191, 193, 194 and arranged in respective groupings relative to the fold line 153 in a manner generally similar to that described above with respect to the fold line 149 for at least partially exposing a locking opening for at least partially receiving a respective locking tab 169 to facilitate formation of the tray 105, as described further herein.

In such an arrangement, the locking flap 181 can be at least partially foldably connected to the top end flap 151 via the cut 185, which can at least partially form a line of weakening. In this regard, the respective pluralities of locking flaps 177, 179, 181 can be at least partially positioned in the second side panel 135 for at least partially receiving a respective locking tab 169 therebetween.

In some embodiments, one or more of the pluralities of locking flaps 177, 179, 181 can be at least partially positioned in the respective end flaps 147, 151.

The blank 103 and the tray 105 formed therefrom can also include one or more product visibility openings 195, for example, to provide product visibility features that can provide a customer with line-of-sight passages into an interior 107 of the tray 105, for example, to inspect food products held therein, and/or to provide ventilation and/or drainage to such food products and/or drainage, for example, for runoff, condensation or other moisture, etc. As shown, one or more of the product visibility openings 195 can be positioned in each of the panels 123, 127, 131, 135, though a different arrangement of openings 195 can be provided without departing from the disclosure.

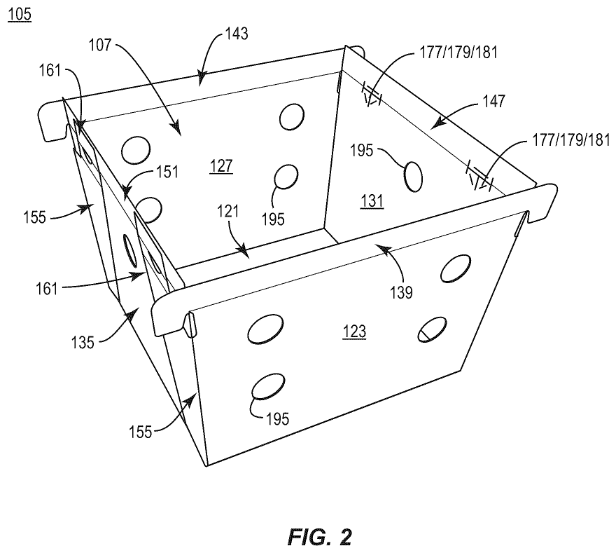

Turning to FIG. 2, according to one embodiment of the disclosure, formation of the tray 105 from the blank 103 can be performed by inverting the blank 103 such that the exterior surface 101 is positioned on a supporting surface and such that an interior surface of the blank 103 can be positioned facing upwardly.

The front panel 123, the back panel 127, the first side panel 131, and the second side panel 135 can be folded upwardly relative to the bottom panel 121 at the respective fold lines 125, 129, 133, 137.

As shown, the side end flap 155 can be folded at the fold line 157 into at least partial face-to-face contact with the front panel 131, with the locking end flap 161 attached thereto carried into at least partial face-to-face contact with the top end flap 147.

Similarly, the opposite side end flap 155 can be folded at the fold line 171 into at least partial face-to-face contact with the back panel 135, and with the locking end flap 161 attached thereto carried into at least partial face-to-face contact with the top end flap 151.

The side end flap 155 attached to the second side panel 127 at the fold line 173 can be folded into at least partial face-to-face contact with the front panel 131, with the locking flap end 161 attached thereto carried into at least partial face-to-face contact with the top end flap 147. Similarly, the opposite side end flap 155 associated with the back panel 127 can be folded at the fold line 175 into at least partial face-to-face contact with the back panel 135, and with the locking end flap 161 attached thereto carried into at least partial face-to-face contact with the top end flap 151.

The aforementioned arrangement of panels and end flaps of the tray 105 can be at least partially maintained with one or more applications of an adhesive such as glue. In some embodiments, an adhesive such as glue can be applied to one or more of the locking end flaps 161 and/or side end flaps 155 along an exterior surface 101 of the blank 103, and/or an adhesive such as glue can be applied to one or more of the side panels 131, 135 along the exterior surface 101 of the blank 103.

The aforementioned arrangement of the tray 105 is illustrated in FIG. 2, in which the top end flaps 139, 143, 147, 151 and locking flaps 161 extend generally upwardly from the respective panels. In such position, the respective locking tabs 169 at least partially defined in the respective locking flaps 161 can be at least partially aligned with a respective plurality of locking flaps 177, 179, 181.

Furthermore, such a rectangular design of the tray 105 as illustrated in FIG. 2, e.g., in which the remainder of panels and end flaps of the tray 105 extend generally upwardly from the bottom panel 121 in generally planar relation, can be advantageous so as to streamline forming equipment, e.g., so as to obviate the need for machine components to engage outwardly protruding portions of a tray. Furthermore, the configuration of the tray 105 shown in FIG. 2 can be suitable for nesting multiple trays 105 in such configuration, e.g., in which the interior 107 of a respective tray 105 at least partially receives a portion of a vertically adjacent tray 105 in a stack, in a space-saving arrangement.

With additional reference to FIG. 3, the top end flaps 147, 151 can be folded downwardly at the respective fold lines 149, 153 to cause the respective locking flaps 161 contacted thereon to fold downwardly in kind at one or both of the respective fold lines 163, 165. It will be understood that the fold lines 163, 165 can cooperate to facilitate relative movement of one or more portions of the locking end flaps 161, e.g., so as to form an articulable hinge. For example, in some embodiments, a portion of the locking end flaps 161 between the fold line 165 and a free edge thereof can move relative to a portion thereof between the fold lines 163, 165.

Upon such movement of the locking flaps 161, the respective locking tabs 169 can at least partially separate from the remainder thereof at the respective cuts 167 to protrude toward the respective plurality of locking flaps 177, 179, 181.

Adjacent locking flaps of the respective pluralities of locking flaps 177, 179, 181 can at least partially separate from one another at the respective cuts 193, 194 and/or can foldably move relative to the respective panel 131, 135 and/or end flap 147, 151 at or about the respective cuts 183, 185, 187, 189, 191 to expose a locking opening through which the respective locking tab 169 can be at least partially received. It will be understood that the aforementioned movement of the respective locking flaps 177, 179, 181 can additionally or alternatively be incidental to the movement of the respective top end flaps 147, 151.

Thereafter, the top end flaps 139, 143 can be folded downwardly at the respective fold lines 141, 145 into at least partial face-to-face contact with respective portions of the top end flaps 147, 151 to form a flange or rim 109 of the tray 105. In some embodiments, the end portions 139b, 143b of the respective top end flaps 139, 143 can be positioned in at least partial face-to-face contact with respective end portions of the top end flap 147, and the end portions 139c, 143c of the respective top end flaps 139, 143 can be positioned in at least partial face-to-face contact with respective portions of the top end flap 151.

In this regard, in some embodiments, the overlapping arrangement of respective top end flaps 139, 143 with respective portions of the top end flaps 147, 151 can facilitate maintenance of the rim 109 in a desired arrangement. In some embodiments, such arrangement can be such that the rim 109 is arranged in a generally parallel and planar arrangement with respect to the bottom panel 121.

In the illustrated embodiment of the tray 105, the panels 123, 127, 131, 135 can extend generally upwardly from the bottom panel 121 so as to form a generally rectangular tray 105. In some embodiments, the panels 123, 127, 131, 135 can extend at least partially obliquely outwardly and upwardly from the bottom panel 121. In other embodiments, the panels 123, 127, 131, 135 can be positioned in generally perpendicular relation with the bottom panel 121.

Still referring to FIG. 3, it will be understood that one or more food products can be dropped, placed, or otherwise positioned in the interior 107 of the tray 105 during or subsequent to the aforementioned steps. In one embodiment, the food products can be tomatoes, though one or more of the food products can be a different food product without departing from the disclosure.

Engagement features of the tray 105 can include the arrangement of the top end flaps 139, 143, 147, 151 and associated features, together or in subcombinations. As shown, the folded arrangement of the top end flaps 139, 143, 147, 151 extending outwardly from the respective panels forms the rim 109 and one or more engagement surfaces for being engaged/supported by an element associated with a forming apparatus for the tray 105, for example a machine element such as a grasper, fork, pincer, rail, etc. In some embodiments, the top end flaps 139, 143, 147, 151 can extend generally perpendicularly outwardly, e.g., away from the interior 107 of the tray 105, from the respective panels 123, 127, 131, 135.

In some embodiments, the exterior (e.g., downward facing) surface of the top end flaps can present engagement surfaces for being engaged/supported by such a machine component. In other embodiments, engagement surfaces can include any combination of one or more of the exterior, interior (e.g., upward facing), and/or side-facing surfaces of one or more of the top end flaps 139, 143, 147, 151.

The positioning of the top end flaps 139, 143, 147, 151 extending away from the panels of the tray 105 also presents a plurality of engagement/support surfaces for engaging/supporting a lidding film, e.g., a plastic or other polymeric film, or other covering structure. In one embodiment, the lidding film can be provided as a polymeric layer that at least partially deforms in the presence of a heat source, e.g., a heat scalable film. The lidding film can thus be positioned extending across a top opening of the tray 105 in contact with one or more surfaces of one or more of the top end flaps 139, 143, 147, 151 to cover the interior 107 of the tray 105 and maintain one or more conditions of the food products held therein, e.g., freshness, ripeness, moisture content, etc. It will be understood that the lidding film can minimize, inhibit, and/or prevent the passage of one or more materials into the interior 107 of the tray 105, for example, condensation or other moisture, insects or other pests, dirt, debris, etc. In one embodiment, the tray 105 can be provided together with the lidding film and one or more food products as a package.

Furthermore, the engagement of the locking tabs 169 through the respective locking flaps 177, 179, 181 and/or associated cuts provides binding and/or reinforcement of a structural integrity/rigidity of the arrangement of the top end flaps 139, 143, 147, 151/the rim 109, as well as the tray 105 as a whole. For example, the enhanced rigidity provided to the arrangement of the top end flaps 139, 143, 147, 151 via engagement of the engagement of the locking tabs 169 through locking flaps 177, 179, 181 and/or associated cuts can minimize, inhibit, and/or prevent bending, bowing, flexing, buckling, curling, other deformation, etc. of the rim 109. In this regard, forces exerted on the rim 109 via tension applied through a lidding film disposed thereon can minimize, inhibit, and/or prevent deformation of the rim 109, e.g., to avoid undesirable product aesthetics, to avoid at least partial disengagement of the lidding film with the rim 109, to maintain a generally planar configuration of the rim 109 for stacking, storage, transport, etc.

It will be understood that additional reinforcement of the rim 109 can be provided via the at least partial face-to-face contacting relation between the locking end flaps 161 and the respective top end flaps 139, 143, which can be enhanced with an adhesive such as glue.

Such an arrangement of the tray 105 supported by the locking features thereof can be suitable for holding relatively heavy quantities of food products, for example, up to and between about 2 lbs and about 3 lbs of food products. In some embodiments, the panels 123 and 127 can have a longitudinal length between the respective fold lines 125, 129 and the respective fold lines 141, 145 of between 4.10 in and 4.20 in, such as about 4.107 in, and the panels 131, 135 can have a lateral length between the respective fold line 133, 137 and the respective fold line 139, 153 between about 4.00 in and about 4.10 in, such as about 4.087 in, though one or more of the panels can have a different dimension without departing from the disclosure. Accordingly, the tray 105 can be provided with a sidewall of considerable depth for at least partially extending around the interior 107 of the tray 105.

It will be understood that one or more of the panels, flaps, and associated features of the blank 103/tray 105 can have a different arrangement or configuration without departing from the disclosure.

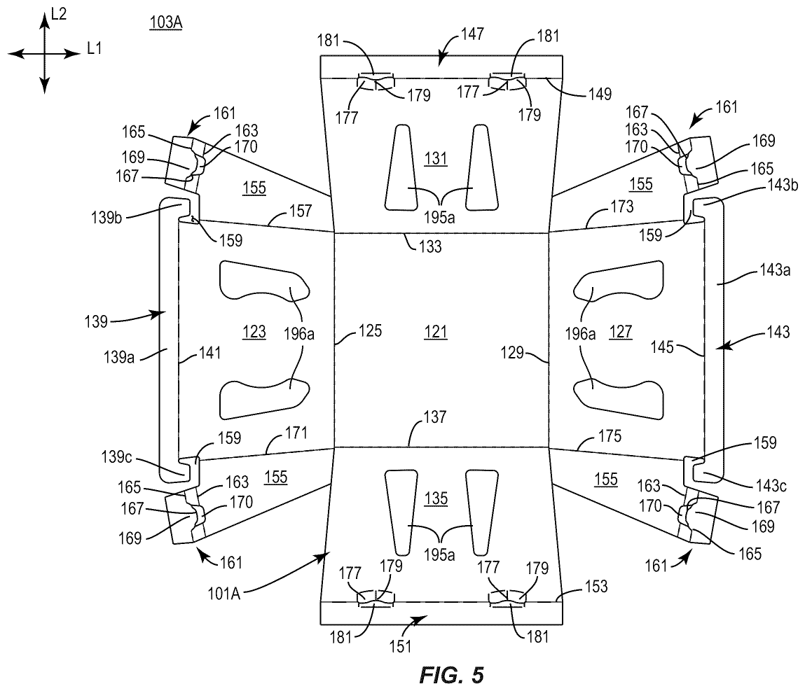

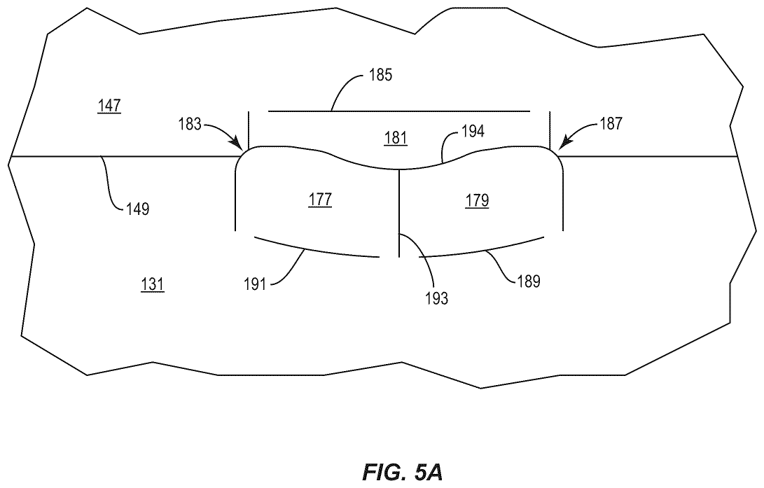

Referring additionally to FIG. 5, the exterior surface 101A of a blank 103A according to an alternative exemplary embodiment of the disclosure is illustrated. As shown, the blank 103A is generally similar to the blank 103 described above, and with a cutout 170 at least partially defined in each respective locking end flap 161 adjacent each respective locking tab 169, for example to facilitate relative movement of the locking flap 169. In some embodiments, the cutout 170 can at least partially extend into the respective side end flap 155.

As also shown, the blank 103A and tray formed therefrom can include product visibility features in the form of spaced pairs of product visibility openings 195A in the respective panels 123, 127 and spaced pairs of product visibility openings 196A in the respective panels 131, 135. As shown, the product visibility openings 195A can have a generally laterally elongate configuration and the product visibility openings 196A can have a generally longitudinally elongate configuration, though one or more of the product visibility openings could have a different configuration without departing from the disclosure.

With additional reference to FIG. 5A, the locking tabs 181, 177, 179 can be at least partially defined by the cuts 183, 185, 187, 191, 189, 193 in the manner described above with respect to the blank 103. However, the cuts 183, 187 can include respective curved segments that intersect respective longitudinally offset vertical/lateral segments of the respective cuts 183, 187. Furthermore, the cut 194 can include a respective central curved segment that intersects the cut 193. The cuts 189, 191, as shown, can have a curved configuration.

The blank 103A can be formed into a tray in a manner generally similar to that described above with respect to the formation of the tray 105 from the blank 103, with similar advantages and functionality.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the trays, to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure tray panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding at least one food product, the tray comprising:
a plurality of panels extending at least partially around an interior of the tray, the plurality of panels comprising a bottom panel, a front panel, a back panel, and at least one side panel;
a plurality of top end flaps foldably connected to a respective panel of the plurality of panels and cooperating to form a rim extending outwardly from the plurality of panels;
a plurality of side end flaps foldably connected to a respective panel of the plurality of panels; and
locking features including a locking end flap foldably connected to at least one side end flap of the plurality of side end flaps, a locking tab protruding from the locking end flap, and a plurality of locking flaps at least partially positioned in a respective panel of the plurality of panels at least partially receiving a respective locking tab therebetween.

2. The tray of claim 1, wherein each locking flap of the plurality of locking flaps is at least partially separated from a respective adjacent locking flap of the plurality of locking flaps at a cut.

3. The tray of claim 2, wherein the plurality of locking flaps comprises a first locking flap at least partially separable from the respective panel of the plurality of panels, a second locking flap at least partially separable from the respective panel of the plurality of panels, and a third locking flap at least partially separable from the respective panel of the plurality of panels.

4. The tray of claim 3, wherein the third locking flap is foldably connected to a respective top end flap of the plurality of top end flaps.

5. The tray of claim 4, wherein the first locking flap abuts the second locking flap, and the third locking flap abuts each of the first locking flap and the second locking flap.

6. The tray of claim 5, wherein the first locking flap is at least partially separable from the second locking flap at a first cut.

7. The tray of claim 6, wherein the third locking flap is at least partially separable from each of the first locking flap and the second locking flap at a second cut that intersects the first cut.

8. The tray of claim 3, wherein the plurality of locking flaps is a first plurality of locking flaps at least partially positioned in a respective panel of the plurality of panels, and the locking features comprise a second plurality of locking flaps at least partially positioned in a respective panel of the plurality of panels.

9. The tray of claim 3, wherein the first plurality of locking flaps is longitudinally spaced apart from the second plurality of locking flaps along the respective panel of the plurality of panels.

10. The tray of claim 3, wherein the plurality of locking flaps is at least partially positioned in the at least one side panel of the plurality of panels.

11. The tray of claim 10, wherein the at least one side panel is a first side panel foldably connected to the bottom panel and the plurality of panels further comprises a second side panel foldably connected to the bottom panel, the plurality of locking flaps is a first plurality of locking flaps at least partially positioned in the first side panel, and the locking features further comprise a second plurality of locking flaps at least partially positioned in the second side panel.

12. The tray of claim 11, wherein the at least one side end flap is a first side end flap foldably connected to one of the front panel and the back panel and the locking end flap is a first locking end flap foldably connected to the first side end flap, the locking tab of the first locking end flap at least partially received between respective locking flaps of the first plurality of locking flaps, the plurality of side end flaps further comprises a second side end flap foldably connected to the other of the front panel and the back panel, the locking features further comprise a second locking end flap foldably connected to the second side end flap and having a locking tab extending therefrom at least partially received between respective locking flaps of the second plurality of locking flaps.

13. A blank for forming a tray for holding at least one food product, the blank comprising:
a plurality of panels for extending at least partially around an interior of the tray formed from the blank, the plurality of panels comprising a bottom panel, a front panel, a back panel, and at least one side panel;
a plurality of top end flaps foldably connected to a respective panel of the plurality of panels for cooperating to form a rim extending outwardly from the plurality of panels when the tray is formed from the blank;
a plurality of side end flaps foldably connected to a respective panel of the plurality of panels; and
locking features comprising a locking end flap foldably connected to at least one side end flap of the plurality of side end flaps, a locking tab protruding from the locking end flap, and a plurality of locking flaps at least partially positioned in a respective panel of the plurality of panels for at least partially receiving a respective locking tab therebetween when the tray is formed from the blank.

14. The blank of claim 13, wherein each locking flap of the plurality of locking flaps is at least partially separable from a respective adjacent locking flap of the plurality of locking flaps at a cut.

15. The blank of claim 14, wherein the plurality of locking flaps comprises a first locking flap at least partially separated from the respective panel of the plurality of panels, a second locking flap at least partially separated from the respective panel of the plurality of panels, and a third locking flap at least partially separated from the respective panel of the plurality of panels.

16. The blank of claim 15, wherein the third locking flap is foldably connected to a respective top end flap of the plurality of top end flaps.

17. The blank of claim 16, wherein the first locking flap is positionable abutting the second locking flap, and the third locking flap is positionable abutting each of the first locking flap and the second locking flap.

18. The blank of claim 17, wherein the first locking flap is at least partially separated from the second locking flap at a first cut.

19. The blank of claim 18, wherein the third locking flap is at least partially separated from each of the first locking flap and the second locking flap at a second cut that intersects the first cut.

20. The blank of claim 15, wherein the plurality of locking flaps is a first plurality of locking flaps at least partially positioned in a respective panel of the plurality of panels, and the locking features comprise a second plurality of locking flaps at least partially positioned in a respective panel of the plurality of panels.

21. The blank of claim 15, wherein the first plurality of locking flaps is longitudinally spaced apart from the second plurality of locking flaps along the respective panel of the plurality of panels.

22. The blank of claim 15, wherein the plurality of locking flaps is at least partially positioned in the at least one side panel of the plurality of panels.

23. The blank of claim 22, wherein the at least one side panel is a first side panel foldably connected to the bottom panel and the plurality of panels further comprises a second side panel foldably connected to the bottom panel, the plurality of locking flaps is a first plurality of locking flaps at least partially positioned in the first side panel, and the locking features further comprise a second plurality of locking flaps at least partially positioned in the second side panel.

24. The blank of claim 23, wherein the at least one side end flap is a first side end flap foldably connected to one of the front panel and the back panel and the locking end flap is a first locking end flap foldably connected to the first side end flap, the locking tab of the first locking end flap for being at least partially received between respective locking flaps of the first plurality of locking flaps when the tray is formed from the blank, the plurality of side end flaps further comprises a second side end flap foldably connected to the other of the front panel and the back panel, the locking features further comprise a second locking end flap foldably connected to the second side end flap and having a locking tab extending therefrom for being at least partially received between respective locking flaps of the second plurality of locking flaps when the tray is formed from the blank.

25. A method of forming a tray for holding at least one food product, the method comprising:
obtaining a blank comprising a plurality of panels, the plurality of panels comprising a bottom panel, a front panel, a back panel, and at least one side panel, the blank further comprising a plurality of top end flaps foldably connected to a respective panel of the plurality of panels, a plurality of side end flaps foldably connected to a respective panel of the plurality of panels, and locking features comprising a locking end flap foldably connected to at least one side end flap of the plurality of side end flaps, a locking tab protruding from the locking end flap, and a plurality of locking flaps at least partially positioned in a respective panel of the plurality of panels;
positioning the plurality of panels extending at least partially around an interior of the tray;
positioning the plurality of top end flaps cooperating to form a rim extending outwardly from the plurality of panels when the tray is formed from the blank; and
positioning the locking tab extending at least partially between the plurality of locking flaps.

26. The method of claim 25, wherein each locking flap of the plurality of locking flaps is at least partially separable from a respective adjacent locking flap of the plurality of locking flaps at a cut.

27. The method of claim 26, wherein the plurality of locking flaps comprises a first locking flap at least partially separable from the respective panel of the plurality of panels, a second locking flap at least partially separable from the respective panel of the plurality of panels, and a third locking flap at least partially separable from the respective panel of the plurality of panels.

28. The method of claim 27, wherein the third locking flap is foldably connected to a respective top end flap of the plurality of top end flaps.

29. The method of claim 28, wherein the first locking flap abuts the second locking flap, and the third locking flap abuts each of the first locking flap and the second locking flap.

30. The method of claim 29, wherein the first locking flap is at least partially separable from the second locking flap at a first cut.

31. The method of claim 30, wherein the third locking flap is at least partially separable from each of the first locking flap and the second locking flap at a second cut that intersects the first cut.

32. The method of claim 27, wherein the plurality of locking flaps is a first plurality of locking flaps at least partially positioned in a respective panel of the plurality of panels, and the locking features comprise a second plurality of locking flaps at least partially positioned in a respective panel of the plurality of panels.

33. The method of claim 27, wherein the first plurality of locking flaps is longitudinally spaced apart from the second plurality of locking flaps along the respective panel of the plurality of panels.

34. The method of claim 27, wherein the plurality of locking flaps is at least partially positioned in the at least one side panel of the plurality of panels.

35. The method of claim 34, wherein the at least one side panel is a first side panel foldably connected to the bottom panel and the plurality of panels further comprises a second side panel foldably connected to the bottom panel, the plurality of locking flaps is a first plurality of locking flaps at least partially positioned in the first side panel, and the locking features further comprise a second plurality of locking flaps at least partially positioned in the second side panel.

36. The method of claim 35, wherein the at least one side end flap is a first side end flap foldably connected to one of the front panel and the back panel and the locking end flap is a first locking end flap foldably connected to the first side end flap, the plurality of side end flaps further comprises a second side end flap foldably connected to the other of the front panel and the back panel, the locking features further comprise a second locking end flap foldably connected to the second side end flap and having a locking tab extending therefrom, the method further comprises positioning the locking tab of the first locking end flap at least partially received between respective locking flaps of the first plurality of locking flaps, and positioning the locking tab of the second locking end flap between respective looking flaps of the second plurality of locking flaps when the tray is formed from the blank.
